(19) United States
(12) Patent Application Publication
(10) Pub. No.: US 2026/0266386 A1
(43) Pub. Date: Sep. 10, 2026

(54) ROTARY VALVE FOR HIGH PURITY APPLICATIONS

(71) Applicant: UOP LLC, Des Plaines, IL (US)

(72) Inventor: Robert Sanger, Mount Prospect, IL (US)

(21) Appl. No.: 19/551,768

(22) Filed: Feb. 27, 2026

Related U.S. Application Data
(60) Provisional application No. 63/769,217, filed on Mar. 10, 2025.

(51) Int. Cl. F16K 11/074; B01D 53/04; B01D 53/047

(52) U.S. Cl. CPC F16K 11/074; B01D 53/0446; B01D 53/047

(57) ABSTRACT

Rotary valves for pressure swing adsorption units are described. The rotary valve top head, bottom head and body are all fabricated from standard piping blind flanges. The rotary valve includes a rotor plate which rotates to connect and seal various fluid passages. Fluid communication passages are machined directly into the rotor plate and connect to the inlets and/or outlets of associated vessels. By designing the passages into the rotor plate, the device can use multiple openings (orifices) of differing sizes to connect two or more vessels while also adjusting the fluid flow rate by the opening size. Once machined these passages can be closed via welding a cover over them.

### RELATED APPLICATIONS

This application claims priority to United States Provisional Patent Application Ser. No. 63/769,217, filed on March 10, 2025, the entirety of which is incorporated herein by reference.

### BACKGROUND

Hydrogen is expected to have significant growth potential because it is a clean-burning fuel. However, hydrogen production is traditionally a significant emitter of CO₂, and government regulations and societal pressures are increasingly taxing or penalizing CO₂ emissions. Consequently, significant competition to lower the cost of hydrogen production while recovering the byproduct CO₂ is anticipated. CO₂ can be separated as a vapor to be supplied to a common pipeline, but more likely it will need to be produced in liquefied form for easy transport by truck or ship due to the current lack of CO₂ pipeline infrastructure in certain areas of the world.

In some applications, greater than 95% CO₂ capture from steam reforming or autothermal reforming or greater than 90% including CO₂ impact from utilities is desired, and may soon be required. However, even lower CO₂ capture percentages from hydrogen production plants, such as 50% to 60%, can be desirable from an economic perspective, especially when the CO₂ recovery system is retrofitted to an existing steam reforming plant. In such cases, CO₂ can be economically recovered from the shifted syngas (pre-combustion capture). In addition to steam reforming hydrogen plants, syngas CO₂ capture can also be desirable in other hydrocarbon or fossil fuel conversion processes, such as autothermal reforming (ATR), gasification, or partial oxidation (POX).

Most existing hydrogen production processes utilize pressure swing adsorption (PSA) to recover high-purity product hydrogen from shifted syngas. The low-pressure tail gas stream from the PSA unit is typically combusted to generate heat or steam for the process. If no stream is sent to a combustor, purge is required to prevent impurity build-up in the process.

In a pressure swing adsorption (PSA) unit, there are a number of adsorption vessels. There are generally at least four vessels, and typically eight to fourteen vessels. The vessels comprise one or more adsorbent layers, generally one to five, and typically two to three. The percentage of the bed for an adsorption layer is typically between 10% and 100%. Different layers of adsorbent have different selectivity for the components in the overhead stream, as is known to those skilled in the art. For example, with a hydrogen production process and recovery of CO₂, some layers contain adsorbent that is for selective adsorption of CO₂ relative to methane, carbon monoxide, nitrogen, argon, and hydrogen, including, but not limited to, layers of activated alumina, silica gel, and sodium Y zeolite. Other layers contain adsorbent that is for selective adsorption of CO₂, methane, carbon monoxide, nitrogen, and argon relative to hydrogen, including, but not limited to, layers of activated carbon, silica gel, and molecular sieve zeolite (e.g., 5A or sodium X zeolite). Those of skill in the art will appreciate that other zeolites could be used and will know how to select appropriate adsorbents.

There is a first opening at one end of the vessel, and a second opening at the opposite end. For convenience, the ends will be referred to as the top and the bottom of the vessel. The first opening at the bottom is selectively connected to a high pressure feed gas inlet line and a low pressure tail gas outlet line. The second opening at the top of the vessel is selectively connected to a high pressure product outlet line and a low pressure purge gas inlet line.

The feed gas enters the vessel at high pressure through the first opening at the bottom of the vessel, and a high pressure, co-current adsorption and product removal step takes place with the product exiting the vessel at high pressure through the second opening at the top of the vessel. There is generally at least one depressurization step and a counter-current purge step. The purge gas enters through the opening at the top of the vessel at low pressure. The purge gas and the adsorbed material are removed at low pressure through the opening at the bottom of the vessel. There is at least one counter-current re-pressurization step following the counter-current purge step.

The adsorption vessels are sequentially connected using a valve system.

The primary purpose of the valve system in a PSA system is to control the flow of gases through the adsorption and desorption cycles. This ensures that the system operates efficiently and that the desired gases are separated with high purity. The valve skid achieves this by managing the timing and sequence of gas flows, directing them through different stages of the PSA process.

The efficiency of a PSA system depends on the precise timing and coordination of the adsorption and desorption cycles. The valve system synchronizes the operation of multiple adsorption columns, ensuring that while one column is in the adsorption phase, another is in the desorption phase, thus maintaining a continuous flow of the product gas.

The valve system includes a network of pipes and manifolds that connect the various valves and components. The design of the piping system ensures minimal pressure drops and efficient flow distribution.

The valve system incorporates various types of valves, including: feed valves which control the flow of the feed gas into the adsorption columns; product valves which regulate the flow of the separated gas to the collection point; exhaust valves which manage the release of waste gases during the desorption phase; and equalization valves which help balance the pressure between different columns during the cycle transitions.

Almost all rotary valves (RVs) have some sealing material, such as polytertafluroethylene, to enable a gas or liquid tight seal. Some RVs have a single sheet that will seal around multiple openings. The sealing material must be held in place as the RV rotates. To enable a proper seal, the sealing material must be under a compressive stress greater than process driving pressure to cause leakage across sealing material. This combination of rotation motion and large compressive stress will cause the sealing material to tend to move and/or rotate.

Seal sheets are typically secured to a solid structure such as a plate that rotates. Most RVs use a combination of holding means to keep the sealing material in place. These holding means often include screws or similar devices. The attachment causes local high stress concentration locations within the seal sheet. These high stress regions can lead to failures due to bearing stress and/or shear stress.

Therefore, there is a need for a rotary valve which is easy to manufacture and maintain.

### BRIEF DESCRIPTION OF THE DRAWINGS

FIG. 1 is an illustration of one embodiment of a PSA unit.

FIG. 2 is an illustration of one embodiment of the rotary valve assembly of the present invention.

FIG. 3 is a front view of one embodiment of the first valve of the rotary valve assembly of the present invention.

FIG. 4 is a cross-section view of the embodiment of the first valve of FIG. 3.

FIG. 5 is a perspective view of one embodiment of the first plate of the first valve of FIG. 4.

FIG. 6 is a perspective view of one embodiment of the second plate of the first valve of FIG. 4.

FIG. 7 is a perspective view of one embodiment of the annular middle plate of the first valve of FIG. 4.

FIG. 8 is a perspective view of one embodiment of the rotor plate of the first valve of FIG. 4.

FIG. 9 is a top view of one embodiment of the rotor plate of FIG. 8.

FIG. 10 is a perspective view of one embodiment of the seal of the first valve of FIG. 4.

FIG. 11 is a bottom view of one embodiment of the rotary plate of FIG. 4.

FIG. 12 is a cross-section view of one embodiment of the second valve of the rotary valve assembly of the present invention.

FIG. 13A is a top view of one embodiment of the rotary plate of the second valve.

FIGS. 13B-C are cross-section views of the rotary plate of FIG. 13A along lines A-A and B-B.

FIG. 14A is a graph of a partial profile of a PSA pressure down step over time.

FIG. 14B is a graph of a partial profile of a PSA pressure up step over time.

FIG. 15 is a graph of torque output of a motor connected to a rotary valve.

FIG. 16 is a graph of a partial profile of a PSA pressure down step over time where pressure is actively controlled to decay in a linear manner.

### DESCRIPTION

The present invention is part of a rotary valve (RV) assembly designed to replace the valve skid, significantly reducing the capital expense for smaller hydrogen purification units.

The unique aspects of the rotary valve assembly enable a very low cost assembly along with lower operating costs due to less expensive maintenance costs compared to other valve systems, including other rotary valve systems.

The valve design enables the use of commercially available components for the major components. The rotary valve (RV) top head, bottom head and body are all fabricated from standard piping blind flanges. These flanges are mass produced and cost less than custom manufactured components. The flanges also enable easy assembly and disassembly of the components using standard tools and sealing gaskets. The flanges are pre-designed for the operating conditions, including for the cyclic service. The bottom head made from a blind flange also acts as one side of the sealing surface. This enables an easy to machine surface using standard machining practices. The flanges also enable the mounting of bearings within them without the need of special bearing mounting housings. Lastly, the configuration has a single simple sealing surface for each valve assembly which reduces the machining cost of having multiple sealing components.

The RV includes a rotating plate which rotates while also sealing various fluid passages (the rotor plate). There are two important aspects of the present invention to improve the performance, cost, and maintenance of the RV. The first aspect is the incorporation of the fluid communication passages in the rotor plate. The passages are machined directly into the rotor plate and connect to the inlets and/or outlets of associated vessels. By designing the passage into the rotor plate, the device can use multiple openings (orifices) of differing sizes and shapes to connect two or more vessels while also adjusting the fluid flow rate by the opening size. Once machined these passages can be closed via welding a cover over them. The second aspect is that the rotor plate is easily removed and independent of other components. This allows easy maintenance and/or replacement of the rotor plate, such as if a sealing surface becomes scratched or damaged. Second, because the rotor plate is an independent, low cost part, it can easily be replaced with a similar part with different passage design/opening sizes to optimize the pressure profiles during operation.

Another aspect of the invention involves the use of a floating seal sheet which is not rigidly attached to any other component. The seal sheet rests on a flat plate and has another flat plate on top of it. The seal sheet has holes that have bearing surfaces which prevent it from rotating.

Because the seal sheet is squeezed with equal force on the top and bottom surfaces, in some embodiments, the bottom surface may be designed to have a higher frictional force than the top surface, which will help prevent movement as the rotor plate rotates relative to the seal sheet. The frictional force is the coefficient of friction multiplied by the normal force, which is a function of the pressure in a low pressure cavity in the seal sheet. The top surface may have a different contact surface area from the bottom surface, which impacts rotational forces. This difference also enables the proper sealing force by connecting a low-pressure zone on the top of the seal sheet below the rotor plate to the lowest pressure vessel at all times. Consequently, the RV maintains proper sealing at all times without the use of mechanical compression devices, such as springs, which other RV's typically use.

The existing process pressures are used to develop the necessary seating stress in the sealing material. It is common for rotary valves to use mechanical devices such as compression springs to develop or aid the necessary seating stress. In contrast, the present invention provides cavities above and below the rotor plate which are at different pressures. The high pressure chamber is defined by the annular middle plate, the rotor plate, and the first plate, and the low pressure cavity is between the bottom surface of the rotor plate and the top of the seal sheet. The size of the cavities is designed to create the optimal seating stress range for the pressures. If the seating stress range is too low, the RV will leak internally, while if it is too large, the seal sheet will wear excessively and likely fail prematurely. The benefits of not using springs or other devices include reducing the complexity and cost of the RV, while improving reliability by eliminating additional failure points.

In some embodiments, the present invention involves the use of a collar/shoulder to keep the sealing material from moving. The collar sits in the through hole in the bottom plate which holds the collar in place. The collar extends above the bottom plate and into the seal sheet, but does not extend all the way through to the opposite side of the seal sheet so that it does not contact the rotor plate or interfere with the sealing. Typically, the collar would extend 50-75% of the thickness of the seal sheet. Using an existing hole required for fluid passage eliminates the need for additional holes and machining in the sealing material. Because the hole is a through hole, it does not create a stress concentration that a counterbore cavity would create. Also, the existing hole is comparatively large, and therefore, the collar will enable a large bearing surface to minimize stress.

One aspect of the invention is a rotary valve assembly. In one embodiment, the rotary valve assembly comprises: a first valve comprising a first plate having a through hole and a shaft cavity; a second plate having two or more through holes and a shafthole; and an annular middle plate between the first plate and the second plate, the annular middle plate defining a cavity. There is a rotor plate positioned in the cavity having a first surface and a second surface; a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3. The annular middle plate, the rotor plate, and the first plate define a chamber. The through hole of the first plate is in selective communication with the through hole of the rotor plate, and the two or more additional through holes in the rotor plate are in selective fluid communication with the two or more through holes in the second plate.

The through holes can be circular or have another shape, including, but not limited to, a parabolic flare, a parabolic horn, or a paraboloid expansion nozzle. An opening in the shape of a parabolic flare, a parabolic horn, or a paraboloid expansion nozzle will have a small opening at the beginning when the pressure differential between Vessel A and Vessel C is maximum, and a large open area at the end when the pressure differential is minimum.

In some embodiments, the rotor plate further comprises a first covered channel extending from the first additional through hole to the second additional through hole at distance greater than or equal to D1 and less than or equal to D3.

In some embodiments, the first covered channel further comprises a notch.

In some embodiments, the first covered channel comprises a curved channel extending less than 180° around the circumference of the rotor plate.

In some embodiments, the rotary valve assembly further comprises a second covered channel in the rotor plate, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3.

In some embodiments, the rotary valve assembly further comprises: a seal sheet having two or more openings corresponding to the two or more additional through holes in the second plate, the seal sheet positioned between a first side of the second plate and a second side of the rotor plate, and wherein the seal sheet is not attached to the second plate or the rotor plate.

In some embodiments, the frictional force of the bottom surface (i.e., the surface in contact with the second plate) of the seal sheet is greater than the coefficient of friction of the top surface (i.e., the surface is contact with the rotor plate) of the seal sheet.

In some embodiments, the top surface of the seal sheet further comprises a low pressure cavity in selective fluid communication with one of the two or more additional through holes in the second plate.

In some embodiments, one or more of the additional through holes in the second plate has a shoulder extending above a top surface of the second plate to hold the seal sheet in place.

In some embodiments, the rotor plate further comprises: a counterbore in a bottom of the rotor plate in selective fluid communication with the low pressure cavity of the seal sheet and the one or more additional through holes in the second plate.

In some embodiments, the rotary valve assembly further comprises a second valve comprising a first plate having a through hole and a shaft hole, a second plate having two or more through holes and a shaft cavity, and an annular middle plate between the first plate and the second plate, the annular middle plate defining a cavity. The rotor plate of the second valve is positioned in the cavity and has a first surface and a second surface, a plurality of through holes, a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3. The annular middle plate, the rotor plate, and the first plate of the second valve define a chamber. The through hole of the first plate of the second valve is in selective communication with the through hole of the rotor plate of the second valve, and the two or more additional through holes in the rotor plate of the second valve being in selective fluid communication with the two or more through holes in the second plate of the second valve. There is a shaft extending from the shaft cavity in the second plate of the second valve through the rotor plate and first plate of the second valve and the second plate and the rotor valve of the first valve to the shaft cavity of the first plate of the first valve, the shaft connected to the rotor plate of the first valve and the rotor plate of the second valve for rotating the rotor plate of the first valve and the rotor plate of the second valve.

In some embodiments, the rotary valve assembly further comprises a second seal sheet having two or more openings corresponding to the two or more through holes in the second plate of the second valve, the second seal sheet positioned between a first side of the second plate of the second valve and a second side of the rotor plate of the second valve and wherein the second seal sheet is not attached to the second bottom plate or the second rotor plate.

In some embodiments, the coefficient of friction of the bottom surface of the second seal sheet is greater than the coefficient of friction of the top surface of the second seal sheet.

In some embodiments, the rotor plate of the second valve further comprises a counterbore in the second side of the rotor plate of the second valve in selective fluid communication with a low pressure cavity of the seal sheet of the second valve and a tail gas outlet in the second plate of the second valve.

Another aspect of the invention is a rotary valve assembly. In one embodiment, the rotary valve assembly comprises a first valve comprising a first plate having a through hole and a shaft cavity; a second plate having two or more through holes and a shafthole; and an annular middle plate between the first plate and the second plate, the annular middle plate defining a cavity. There is a rotor plate positioned in the cavity having a first surface and a second surface; a shaft hole; a through hole comprising an opening having an inner distance D1 from a center of the rotor plate, a center distance D2, and an outer distance D3; two or more additional through holes, each of the additional through holes being smaller than the first through hole in the rotor plate, and the two or more additional through holes being positioned on the rotor plate at a distance greater than or equal to D1 and less than or equal to D3; and a first covered channel extending from a first additional through hole to a second additional through hole at distance greater than or equal to D1 and less than or equal to D3. The annular middle plate, the rotor plate, and the first plate define a chamber. The through hole of the first plate is in selective communication with the through hole of the rotor plate, and the two or more additional through holes in the rotor plate are in selective fluid communication with the two or more through holes in the second plate. There is a second valve comprising a first plate having a through hole and a shaft hole, a second plate having two or more through holes and a shaft cavity, and an annular middle plate between the first plate and the second plate, the annular middle plate defining a cavity. The rotor plate is positioned in the cavity of the second valve having a first surface and a second surface, a plurality of through holes, a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3. The annular middle plate, the rotor plate, and the first plate of the second valve define a chamber. The through hole of the first plate of the second valve is in selective communication with the through hole of the rotor plate of the second valve, and the two or more additional through holes in the rotor plate of the second valve are in selective fluid communication with the two or more through holes in the second plate of the second valve. There is a shaft extending from the shaft cavity in the second plate of the second valve through the rotor plate and first plate of the second valve and the second plate and the rotor valve of the first valve to the shaft cavity of the first plate of the first valve, the shaft connected to the rotor plate of the first valve and the rotor plate of the second valve for rotating the rotor plate of the first valve and the rotor plate of the second valve.

In some embodiments, the rotor plate of the second valve further comprises a first covered channel extending from the first additional through hole to the second additional through hole at distance greater than or equal to D1 and less than or equal to D3.

In some embodiments, the rotary valve assembly further comprises a second covered channel in the rotor plate of the first valve, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3,

In some embodiments, the rotary valve assembly further comprises: a seal sheet having two or more openings corresponding to the two or more additional through holes in the second plate, the seal sheet positioned between a first side of the second plate and a second side of the rotor plate of the first valve, and wherein the seal sheet is not attached to the second plate or the rotor plate of the first valve; or a second seal sheet having two or more openings corresponding to the two or more additional through holes in the second plate, the seal sheet positioned between a first side of the second plate and a second side of the rotor plate of the second valve, and wherein the seal sheet is not attached to the second plate or the rotor plate of the second valve; or both.

In some embodiments, the coefficient of friction of the bottom surface of the seal sheet of the first valve is greater than the coefficient of friction of the top surface of the seal sheet of the first valve; or a coefficient of friction of the bottom surface of the seal sheet of the second valve is greater than the coefficient of friction of the top surface of the seal sheet of the second valve; or both.

In some embodiments, the top surface of the seal sheet of the first valve further comprises a low pressure cavity in fluid communication with one of the two or more additional through holes in the second plate of the first valve; or wherein the top surface of the seal sheet of the second valve further comprises a low pressure cavity in fluid communication with one of the two or more additional through holes in the second plate of the second valve, or both.

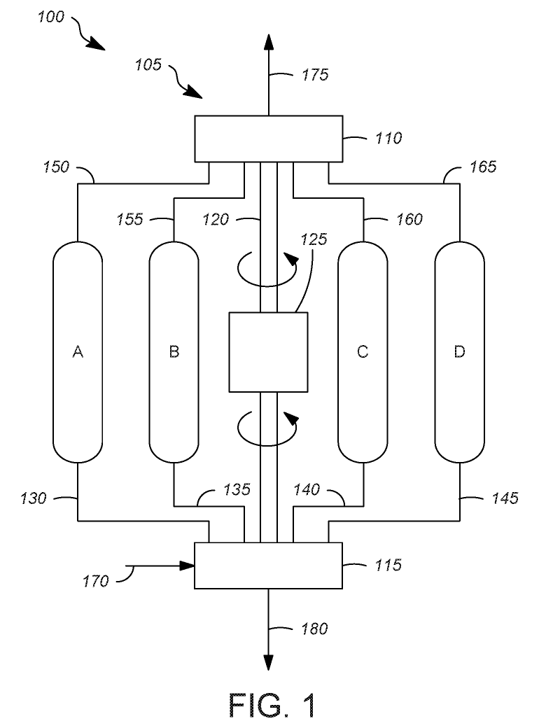

FIG. 1. illustrates one embodiment of a pressure swing adsorption unit 100 comprising four vessels and a rotary valve assembly 105. The rotary valve assembly 105 comprises a first valve 110 and a second valve 115 connected to a rotating shaft 120. Motor 125 (or other means of rotating the shaft 120) rotates the first and second valves 110 and 115 among vessels A, B, C, and D, as described in more detail below.

Lines 130, 135, 140, and 145 connect the second valve 115 with the bottom of vessels A, B, C, and D, respectively, while lines 150, 155, 160, 165 connect the first valve 110 with the top of vessels A, B, C, and D, respectively.

The feed stream 170 enters the second valve 115 and is sent through line 130 to vessel A where the impurities are adsorbed in one or more beds. The purified hydrogen is sent to the first valve 110 through line 150. The product stream 175 exits the first valve 110.

A portion of the purified hydrogen is sent to vessel C through line 160 where it flows in a counter-current direction to the flow for adsorption (i.e., from the first valve 110 through vessel C to the second valve 115) to remove the adsorbed components. The low pressure tail gas stream comprising the components removed from the adsorbent in vessel C are sent to the second valve 115 through line 140. The tail gas stream 180 exits the second valve 115.

In some embodiments, vessel B may be pressurized and vessel D may be depressurized by gas passing from vessel D through line 165 to the first valve 110 and from the first valve 110 through line 155 to vessel B.

First and second valves 110 and 115 are indexed to vessels B and D, and the process is repeated.

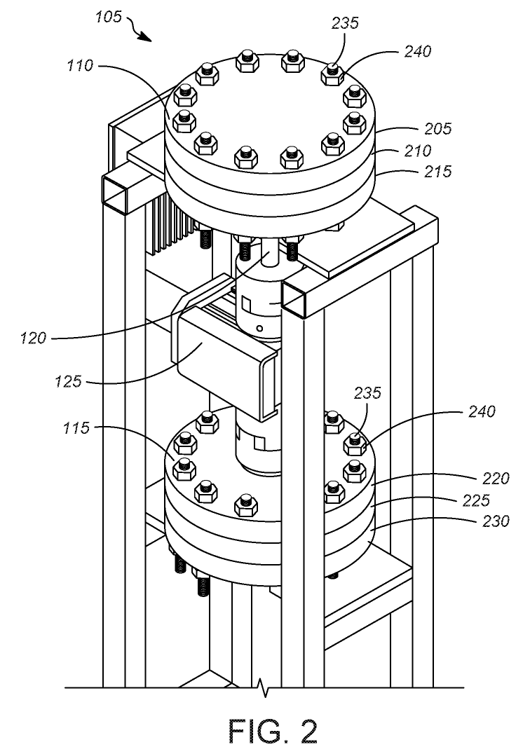

FIG. 2 illustrates the rotary valve assembly 105. The first valve 110 comprises a first plate 205, an annular middle plate 210, and a second plate 215. The second valve 115 comprises a first plate 220, an annular middle plate 225, and a second plate 230. The plates of the first and second valves are connected using bolts 235 and nuts 240.

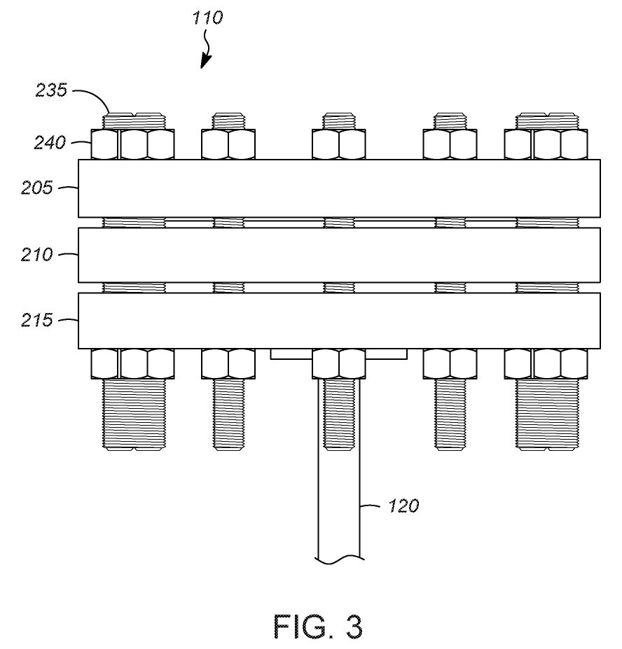

FIGS. 3-11 show the first valve 110 in more detail.

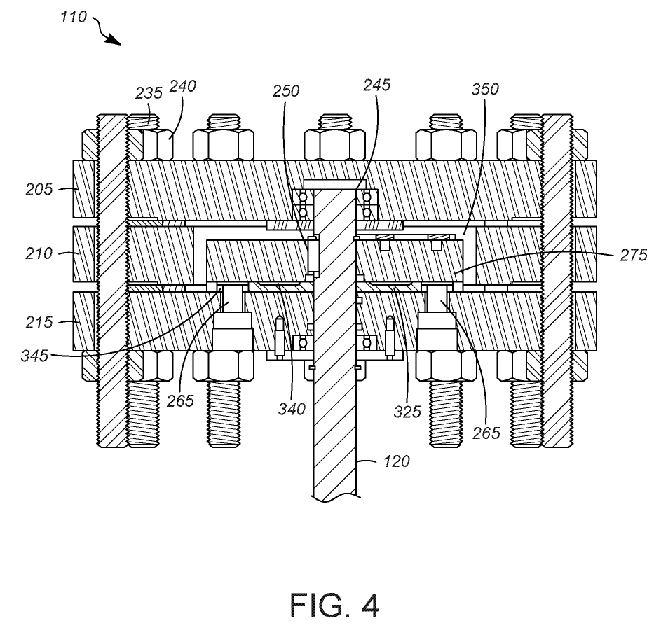

FIG. 3 is a side view of the first valve, and FIG. 4 is a cross-section view. As shown in FIG. 4, there is a shaft cavity 245 in the first plate 205 to receive the shaft 120. As shown, the shaft cavity 245 extends partially through the thickness of the first plate 205. The shaft cavity 245 contains bearings 250 for the rotation of the shaft 120. Alternatively, the shaft cavity 245 could extend all the way through the first plate 205. In this case, the hole could be sealed with a plate or a gasket. In another embodiment, the shaft could extend through top of the first plate 205, and there could be shaft seals at the upper end of the first plate 205.

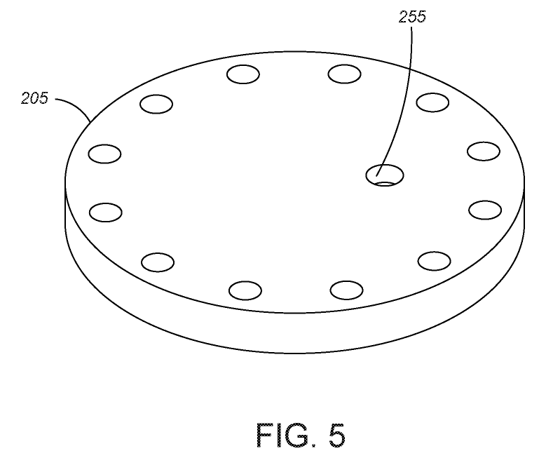

The first plate 205 also has a through hole 255, as shown FIG. 5 (not shown in FIG. 4).

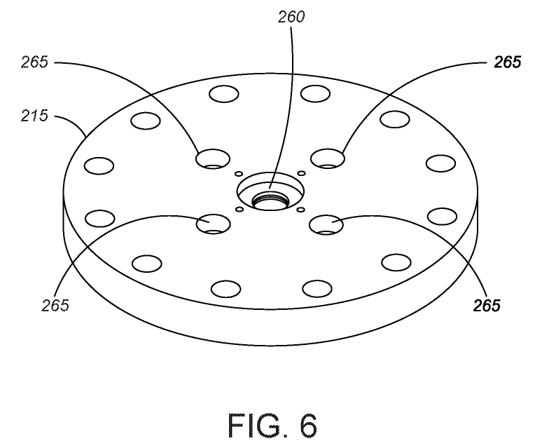

FIG. 6 shows the second plate 215 with shaft hole 260 and through holes 265A, 265B, 265C, and 265D. Through holes 265A, 265B, 265C, and 265D in the second plate 215 connect to the top of vessels A, B, C, and D through lines 150, 155, 160, and 165, as seen in FIG. 1.

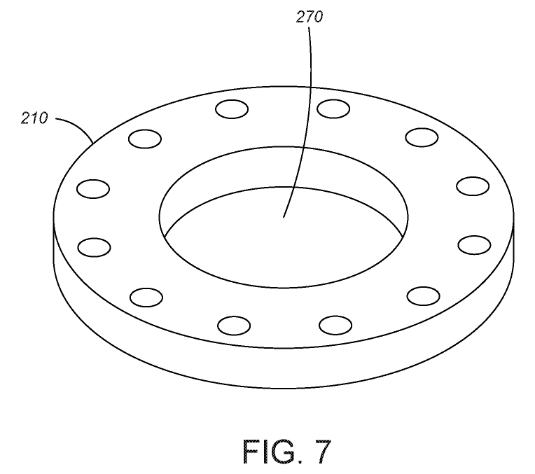

The annular middle plate 210 defines a cavity 270 in the center, as shown in FIG. 7.

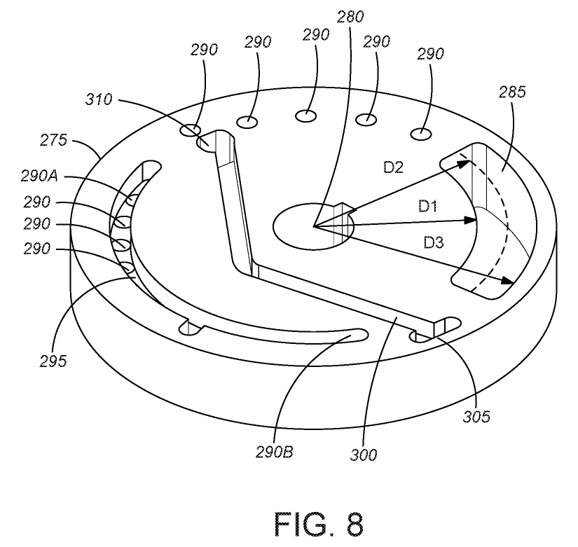

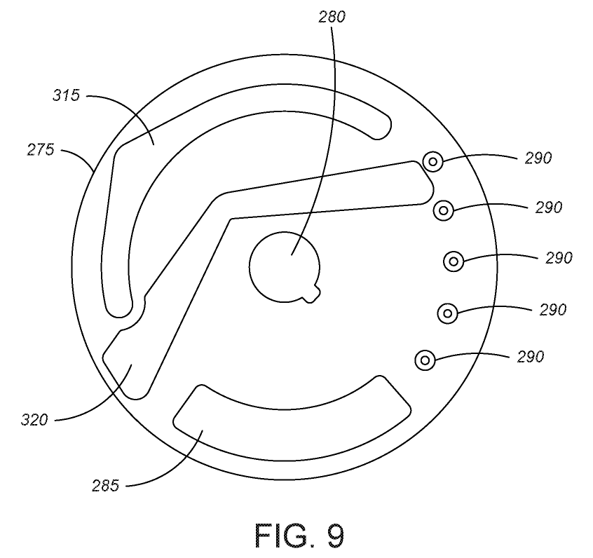

FIGS. 8-9 show a perspective view and a top view of a rotor plate 275. The rotor plate 275 has a shaft hole 280 which is connected to, and rotates with, the shaft 120. The rotor plate 275 has a through hole 285 which sequentially provides a flow path from the through holes 265A, 265B, 265C, and 265D in the second plate 215 to the through hole 255 in the first plate 205 as the rotor plate 275 rotates. The through hole 285 has an inner distance D1 from the center point, a center distance D2 from the center point, and an outer distance D3 from the center point.

There are additional though holes 290 in the rotor plate 275. The additional through holes 290 are smaller than the through hole 285 and are positioned at a distance greater than or equal to D1 and less than or equal to D3.

Two or more of the additional through holes may be located in a first covered channel 295. The first covered channel 295 extends from one of the additional through holes 290 to another. The first covered channel which does not extend all the way through the rotor plate 275. The first covered channel 295 is on the opposite side of the rotor plate 275 from the first through hole 285. The through holes 290 in the covered channel 295 provide a path for the flow of gas from the first valve 110 to the vessel where the adsorbed components are being desorbed. The first covered channel 295 is positioned at a distance greater than or equal to D1 and less than or equal to D3.

The rotor plate 275 may include a second covered channel 300 which extends from one additional through hole 305 to a second additional through hole 310. The additional through hole 305 is between one end of the through hole 285 and an additional through hole 290B, and additional through hole 310 is between the other end of the through hole 285 and an additional through hole 290A.

The first and second covered channels 295 and 300 may be machined into the rotor plate 275 and cover plates 315 and 320 may be welded over the machined channels.

Returning to FIG. 4, the rotor plate 275 is positioned in the cavity 270. The rotor plate 275 rotates with the shaft 120. There is a seal sheet 325 between the top surface of the second plate 215 and the bottom surface of the rotor plate 275. The seal sheet 325 is not attached to the second plate 215 or the rotor plate 275.

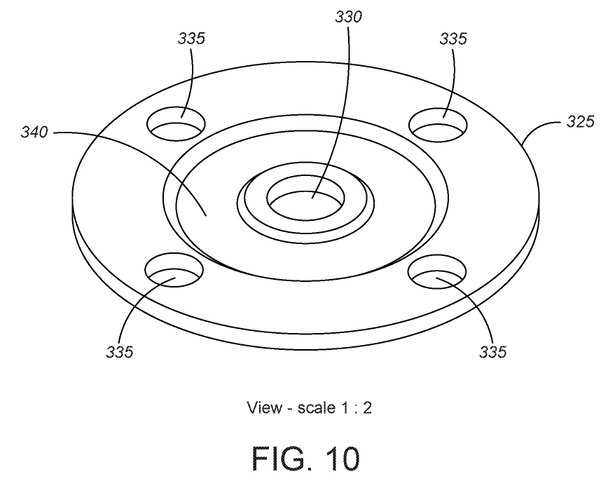

As shown in FIG. 10, the seal sheet 325 has a shaft hole 330 and four openings 335 corresponding to the four though holes 265A-D in the second plate 215 (see FIG. 4). The seal sheet 325 also has a low pressure cavity 340 on the upper surface. The frictional force at the bottom surface of the seal sheet 325 to the flow for adsorption (i.e., from the first valve 110 through vessel C to the second valve 115) may be greater than the frictional force at the top surface (i.e., the side facing the rotor plate 275) (for example, due to different surface finishes on the bottom of the rotor plate 275 and the top of the second plate 215) to assist in keeping the seal sheet from moving. One or more of the through holes 265 in the second plate 215 may have a shoulder 345 extending above the surface of the second plate 215 and into the opening in the seal sheet 325 to help hold the seal sheet 325 in place (see FIG. 4).

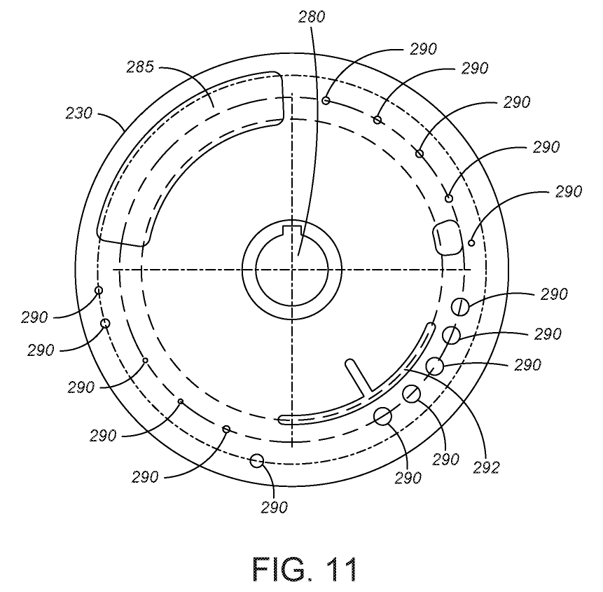

The low pressure cavity 340 is in fluid communication with one of the additional through holes 290 in the second plate 215. As shown in FIG. 11, there is a counterbore 292 in the bottom of the rotor plate 275. This allows selective connection between one or more of the additional though holes 290 in the second plate 230 and the low pressure cavity 340 in the seal sheet 325.

As shown in FIG. 4, a chamber 350 is defined by the inside of the annular middle plate 210, the rotor plate 275, and the first plate 205. The chamber 350 provides a flow path from the through holes 265 (FIG. 6) in the second plate 215 and the through hole 285 (FIG. 8) in the rotor plate 275 to the through hole 255 (FIG. 5) in the first plate 205.

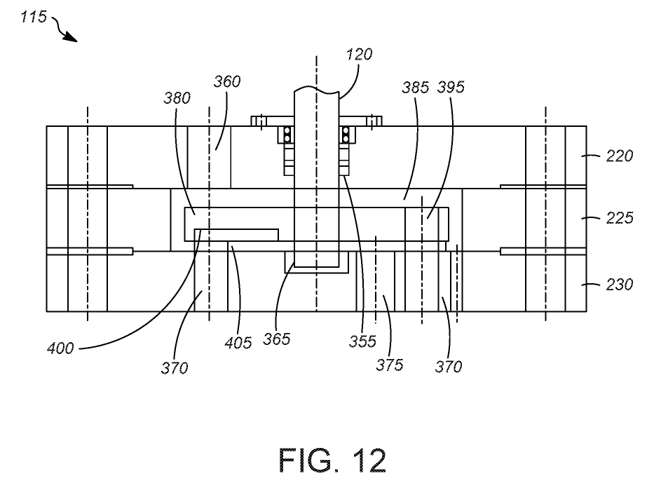

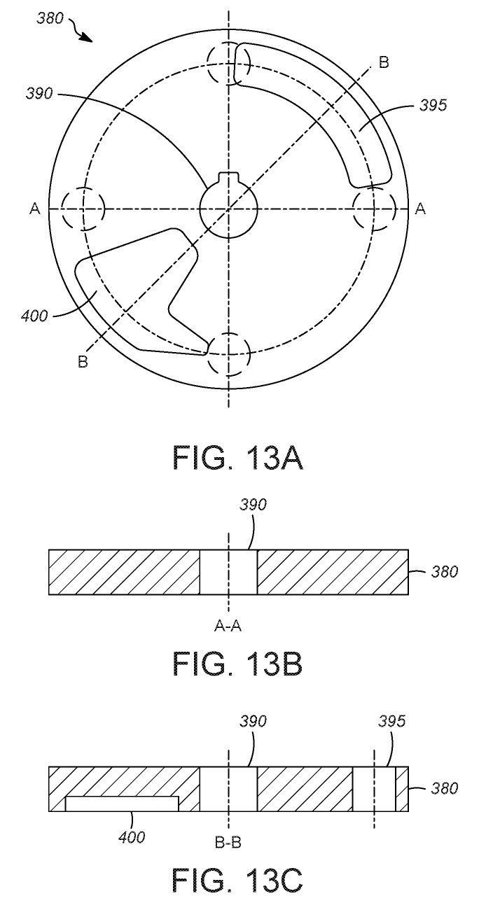

FIGS. 12 and 13A-C show the second valve 115 which comprises the first plate 220, the annular middle plate 225, and the second plate 230. The first plate 220 of the second valve 115 has a shaft hole 355, and a through hole 360. The second plate 230 has a shaft cavity 365 and through holes 370, and a tail gas outlet through hole 375. The rotor plate 380 is positioned in chamber 385 defined by the inside of the annular middle plate 225, the rotor plate 380, and the first plate 220. The rotor plate has a shaft hole 390, a through hole 395, and a counterbore 400. The chamber 385 provides a flow path from the through hole 360 in the first plate 220 and the through hole 395 in the rotor plate 380 to the through holes 370 in the second plate 230. As the rotor plate 380 rotates, it selectively connects counterbore 400 in the rotor plate 380 to a low pressure cavity in the seal sheet 405 (like the low pressure cavity 340 in seal sheet 325 shown in FIG. 10) and to the tail gas outlet through hole 375 in the second plate 230.

### Example

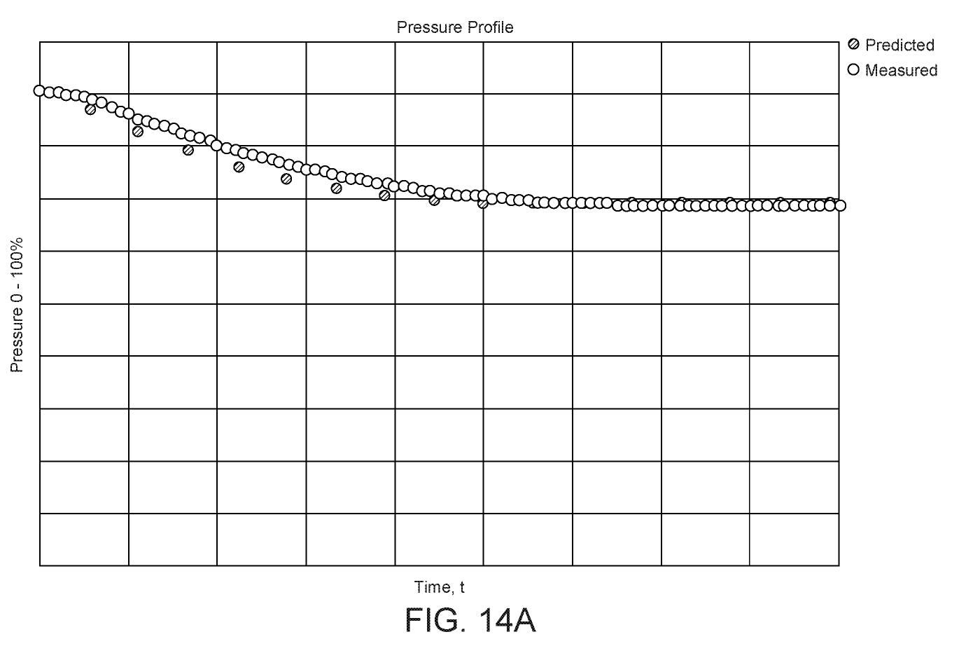

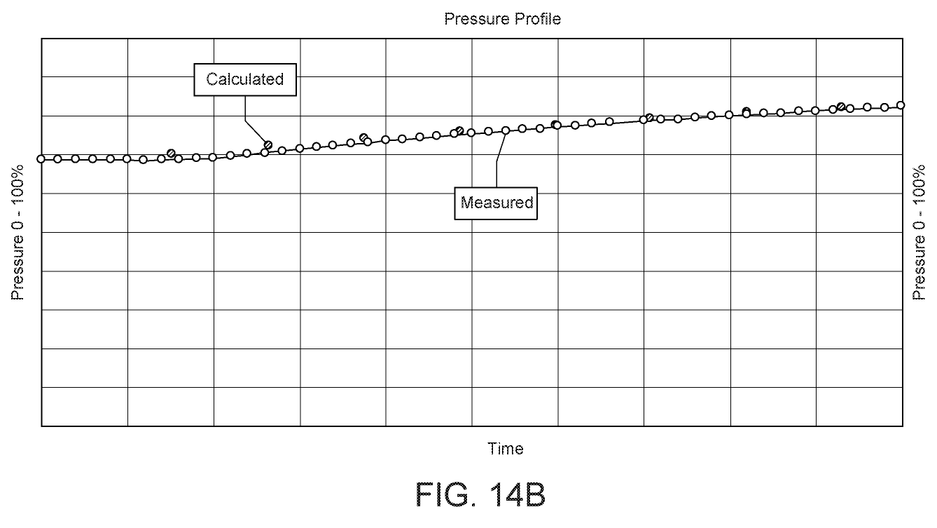

FIGS. 14A and 14B illustrate a comparison between a calculated pressure profile and a measured pressure profile of a single pressure swing adsorption (PSA) bed as a function of time. In the illustrated embodiment, the pressure profile is measured as flow discharges from a first PSA (FIG. 14A) bed and received by second PSA bed (FIG. 14B) routed through a rotary valve. A physical test was conducted utilizing compressed air as a simulant to measure pressure decay in the discharging PSA bed and pressure rise in the receiving PSA bed as a function of time using pressure sensors located throughout the test apparatus. A hydraulic mathematical model was developed accounting for a plurality of hydraulic resistances within a flow path of the rotary valve, piping, and PSA bed. As shown, the comparison of partial discharge step and partial pressure receiving step demonstrates a substantial correlation between the calculated pressure profile and the actual pressure profile.

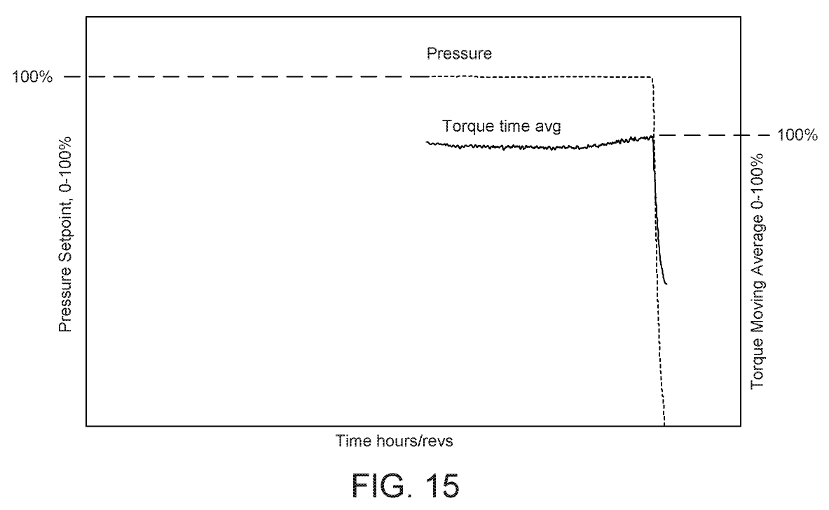

FIG. 15 illustrates incoming fluid pressure to the rotary valve and a time-averaged torque imparted by a drive mechanism, such as a motor or hydraulic drive, to rotate the rotary valve at a predetermined rotational speed, as measured on the test apparatus. In one embodiment, the incoming fluid pressure is substantially constant as a fluid (e.g., compressed air) flows from a first PSA bed to a second PSA bed through the rotary valve over a plurality of revolutions, thereby facilitating a plurality of discharge and receiving steps. Relative movement between a rotor plate and a seal generates frictional forces which may vary during a single revolution or over the operating life of the rotary valve. As shown in FIG. 15, the torque required to rotate the rotor plate is maintained within a predetermined range over a plurality of revolutions and is substantially independent of varying frictional forces or seal wear. This demonstrates that the rotary valve is configured to maintain operational integrity and sealing without the use of a mechanical compression device typically utilized in conventional rotary valve assemblies.

The experimental data illustrated in FIGS. 14A, 14B, and 15 demonstrate that the rotary valve is configured to operate according to the disclosed embodiments. Specifically, the correlation between the calculated and measured pressure profiles, in combination with the consistent torque measurements, indicates that the rotor sealing interface maintains structural and functional integrity under operational conditions. The consistency of these results further verifies that the sealing engagement is substantially robust and capable of maintaining a fluid-tight seal without necessitating external mechanical compression means such as spring typically utilized in conventional rotary valve assemblies.

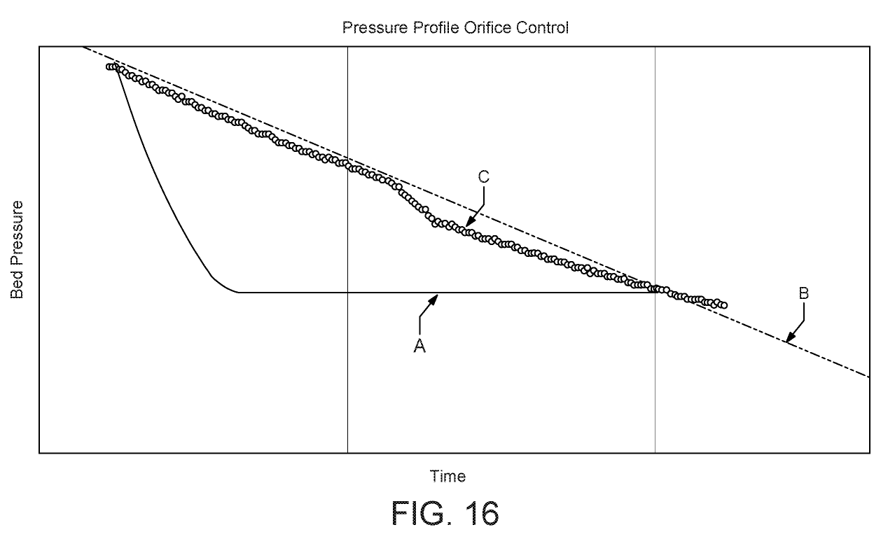

FIG. 16 depicts a comparative graphical representation of pressure profiles as a function of time during a gas discharge event. Specifically, FIG. 16 illustrates the transition of pressurized gas from a PSA bed at a relatively high pressure to another receiving PSA bed at a relatively lower pressure in which the gas is routed through at least one orifice disposed within a rotary valve (RV). The exemplary pressure profile corresponding to fluid discharge through a fixed choked orifice (A) exhibits a substantially exponential decay. The second pressure profile (B) corresponds to an orifice configuration having a cross-sectional flow area that increases continuously over a temporal period. The second pressure profile exhibits a substantially linear pressure decrease over time, notwithstanding the concurrent reduction in the pressure differential driving said fluid flow. A substantially linear pressure decay profile is desired for one or more pressuring-de pressuring events in a PSA process. A physical test (C) was performed utilizing compressed air as a simulant to replicate the substantially linear pressure profile. In this configuration, the RV comprises a rotor plate having a first through-orifice and a plurality of additional through-orifices. In the illustrated embodiment, each of the plurality of additional through-orifices comprises a cross-sectional area smaller than a cross-sectional area of the first through-orifice. Experimental pressure data was acquired via a plurality of pressure sensors disposed within a test apparatus and plotted against the exemplary exponential and linear decay profiles. FIG. 16 demonstrates that a plurality of through-orifices may be selectively dimensioned and spatially distributed on the rotor plate to provide a cumulative open area that increases monotonically over time. Such an arrangement maintains a substantially linear pressure decay despite the diminishing pressure differential that serves as the driving force for the fluid discharge.

### Specific Embodiments

While the following is described in conjunction with specific embodiments, it will be understood that this description is intended to illustrate and not limit the scope of the preceding description and the appended claims.

A first embodiment of the invention is an apparatus comprising a first valve comprising a first plate having a through hole and a shaft cavity; a second plate having two or more through holes and a shafthole; and an annular middle plate between the first plate and the second plate, the annular middle plate defining a cavity; a rotor plate positioned in the cavity having a first surface and a second surface; a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3; a chamber defined by the annular middle plate, the rotor plate, and the first plate; the through hole of the first plate being in selective communication with the through hole of the rotor plate, and the two or more additional through holes in the rotor plate being in selective fluid communication with the two or more through holes in the second plate. An embodiment of the invention is one, any or all of prior embodiments in this paragraph up through the first embodiment in this paragraph wherein the rotor plate further comprises a first covered channel extending from the first additional through hole to the second additional through hole at distance greater than or equal to D1 and less than or equal to D3. An embodiment of the invention is one, any or all of prior embodiments in this paragraph up through the first embodiment in this paragraph wherein the first covered channel further comprises a notch. An embodiment of the invention is one, any or all of prior embodiments in this paragraph up through the first embodiment in this paragraph wherein the first covered channel comprises a curved channel extending less than 180° around the circumference of the rotor plate. An embodiment of the invention is one, any or all of prior embodiments in this paragraph up through the first embodiment in this paragraph further comprising a second covered channel in the rotor plate, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3. An embodiment of the invention is one, any or all of prior embodiments in this paragraph up through the first embodiment in this paragraph further comprising a seal sheet having two or more openings corresponding to the two or more additional through holes in the second plate, the seal sheet positioned between a first side of the second plate and a second side of the rotor plate, and wherein the seal sheet is not attached to the second plate or the rotor plate. An embodiment of the invention is one, any or all of prior embodiments in this paragraph up through the first embodiment in this paragraph wherein a coefficient of friction of a bottom surface of the seal sheet is greater than a coefficient of friction of a top surface of the seal sheet. An embodiment of the invention is one, any or all of prior embodiments in this paragraph up through the first embodiment in this paragraph wherein the top surface of the seal sheet further comprises a low pressure cavity in selective fluid communication with one of the two or more additional through holes in the second plate. An embodiment of the invention is one, any or all of prior embodiments in this paragraph up through the first embodiment in this paragraph wherein one or more of the additional through holes in the second plate has a shoulder extending above a top surface of the second plate to hold the seal sheet in place. An embodiment of the invention is one, any or all of prior embodiments in this paragraph up through the first embodiment in this paragraph wherein the rotor plate further comprises a counterbore in a bottom of the rotor plate in selective fluid communication with the low pressure cavity of the seal sheet and the one or more additional through holes in the second plate. An embodiment of the invention is one, any or all of prior embodiments in this paragraph up through the first embodiment in this paragraph further comprising a second valve comprising a first plate having a through hole and a shaft hole, a second plate having two or more through holes and a shaft cavity, and an annular middle plate between the first plate and the second plate, the annular middle plate defining a cavity; a rotor plate of the second valve positioned in the cavity having a first surface and a second surface, a plurality of through holes, a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3; a chamber defined by the annular middle plate, the rotor plate, and the first plate of the second valve; the through hole of the first plate of the second valve being in selective communication with the through hole of the rotor plate of the second valve, and the two or more additional through holes in the rotor plate of the second valve being in selective fluid communication with the two or more through holes in the second plate of the second valve; and a shaft extending from the shaft cavity in the second plate of the second valve through the rotor plate and first plate of the second valve and the second plate and the rotor valve of the first valve to the shaft cavity of the first plate of the first valve, the shaft connected to the rotor plate of the first valve and the rotor plate of the second valve for rotating the rotor plate of the first valve and the rotor plate of the second valve. An embodiment of the invention is one, any or all of prior embodiments in this paragraph up through the first embodiment in this paragraph further comprising a second seal sheet having two or more openings corresponding to the two or more through holes in the second plate of the second valve, the second seal sheet positioned between a first side of the second plate of the second valve and a second side of the rotor plate of the second valve and wherein the second seal sheet is not attached to the second bottom plate or the second rotor plate. An embodiment of the invention is one, any or all of prior embodiments in this paragraph up through the first embodiment in this paragraph wherein a coefficient of friction of a bottom surface of the second seal sheet is greater than a coefficient of friction of a top surface of the second seal sheet. An embodiment of the invention is one, any or all of prior embodiments in this paragraph up through the first embodiment in this paragraph wherein the rotor plate of the second valve further comprises a counterbore in the second side of the rotor plate of the second valve in selective fluid communication with a low pressure cavity of the seal sheet of the second valve and a tail gas outlet in the second plate of the second valve.

A second embodiment of the invention is an apparatus comprising a first valve comprising a first plate having a through hole and a shaft cavity; a second plate having two or more through holes and a shafthole; and an annular middle plate between the first plate and the second plate, the annular middle plate defining a cavity; a rotor plate positioned in the cavity having a first surface and a second surface; a shaft hole; a through hole comprising an opening having an inner distance D1 from a center of the rotor plate, a center distance D2, and an outer distance D3; two or more additional through holes, each of the additional through holes being smaller than the first through hole in the rotor plate, and the two or more additional through holes being positioned on the rotor plate at a distance greater than or equal to D1 and less than or equal to D3; and a first covered channel extending from a first additional through hole to a second additional through hole at distance greater than or equal to D1 and less than or equal to D3; a chamber defined by the annular middle plate, the rotor plate, and the first plate; the through hole of the first plate being in selective communication with the through hole of the rotor plate, and the two or more additional through holes in the rotor plate being in selective fluid communication with the two or more through holes in the second plate; a second valve comprising a first plate having a through hole and a shaft hole, a second plate having two or more through holes and a shaft cavity, and an annular middle plate between the first plate and the second plate, the annular middle plate defining a cavity; a rotor plate of the second positioned in the cavity of the second valve having a first surface and a second surface, a plurality of through holes, a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3; a chamber defined by the annular middle plate, the rotor plate, and the first plate of the second valve; the through hole of the first plate of the second valve being in selective communication with the through hole of the rotor plate of the second valve, and the two or more additional through holes in the rotor plate of the second valve being in selective fluid communication with the two or more through holes in the second plate of the second valve; and a shaft extending from the shaft cavity in the second plate of the second valve through the rotor plate and first plate of the second valve and the second plate and the rotor valve of the first valve to the shaft cavity of the first plate of the first valve, the shaft connected to the rotor plate of the first valve and the rotor plate of the second valve for rotating the rotor plate of the first valve and the rotor plate of the second valve. An embodiment of the invention is one, any or all of prior embodiments in this paragraph up through the second embodiment in this paragraph wherein the rotor plate of the second valve further comprises a first covered channel extending from the first additional through hole to the second additional through hole at distance greater than or equal to D1 and less than or equal to D3. An embodiment of the invention is one, any or all of prior embodiments in this paragraph up through the second embodiment in this paragraph further comprising a second covered channel in the rotor plate of the first valve, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3; or a second covered channel in the rotor plate of the second valve, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3; or both. An embodiment of the invention is one, any or all of prior embodiments in this paragraph up through the second embodiment in this paragraph further comprising a seal sheet having two or more openings corresponding to the two or more additional through holes in the second plate, the seal sheet positioned between a first side of the second plate and a second side of the rotor plate of the first valve, and wherein the seal sheet is not attached to the second plate or the rotor plate of the first valve; or a second seal sheet having two or more openings corresponding to the two or more additional through holes in the second plate, the seal sheet positioned between a first side of the second plate and a second side of the rotor plate of the second valve, and wherein the seal sheet is not attached to the second plate or the rotor plate of the second valve; or both. An embodiment of the invention is one, any or all of prior embodiments in this paragraph up through the second embodiment in this paragraph wherein a coefficient of friction of a bottom surface of the seal sheet of the first valve is greater than a coefficient of friction of a top surface of the seal sheet of the first valve; or wherein a coefficient of friction of a bottom surface of the seal sheet of the second valve is greater than a coefficient of friction of a top surface of the seal sheet of the second valve; or both. An embodiment of the invention is one, any or all of prior embodiments in this paragraph up through the second embodiment in this paragraph wherein the top surface of the seal sheet of the first valve further comprises a low pressure cavity in fluid communication with one of the two or more additional through holes in the second plate of the first valve; or wherein the top surface of the seal sheet of the second valve further comprises a low pressure cavity in fluid communication with one of the two or more additional through holes in the second plate of the second valve; or both.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A rotary valve assembly comprising:
a first valve comprising a first plate having a through hole and a shaft cavity; a second plate having two or more through holes and a shafthole; and an annular middle plate between the first plate and the second plate, the annular middle plate defining a cavity;
a rotor plate positioned in the cavity having a first surface and a second surface; a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3; and
a chamber defined by the annular middle plate, the rotor plate, and the first plate;
the through hole of the first plate being in selective communication with the through hole of the rotor plate, and the two or more additional through holes in the rotor plate being in selective fluid communication with the two or more through holes in the second plate.

2. The rotary valve assembly of claim 1 wherein the rotor plate further comprises a first covered channel extending from the first additional through hole to the second additional through hole at distance greater than or equal to D1 and less than or equal to D3.

3. The rotary valve assembly of claim 2 wherein the first covered channel further comprises a notch.

4. The rotary valve assembly of claim 2 wherein the first covered channel comprises a curved channel extending less than 180° around the circumference of the rotor plate.

5. The rotary valve assembly of claim 1 further comprising a second covered channel in the rotor plate, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3.

6. The rotary valve assembly of claim 1 further comprising:
a seal sheet having two or more openings corresponding to the two or more additional through holes in the second plate, the seal sheet positioned between a first side of the second plate and a second side of the rotor plate, and wherein the seal sheet is not attached to the second plate or the rotor plate.

7. The rotary valve assembly of claim 6 wherein a coefficient of friction of a bottom surface of the seal sheet is greater than a coefficient of friction of a top surface of the seal sheet.

8. The rotary valve assembly of claim 6 wherein the top surface of the seal sheet further comprises a low pressure cavity in selective fluid communication with one of the two or more additional through holes in the second plate.

9. The rotary valve assembly of claim 6 wherein one or more of the additional through holes in the second plate has a shoulder extending above a top surface of the second plate to hold the seal sheet in place.

10. The rotary valve assembly of claim 6 wherein the rotor plate further comprises:
a counterbore in a bottom of the rotor plate in selective fluid communication with the low pressure cavity of the seal sheet and the one or more additional through holes in the second plate.

11. The rotary valve assembly of claim 1 further comprising:
a second valve comprising a first plate having a through hole and a shaft hole, a second plate having two or more through holes and a shaft cavity, and an annular middle plate between the first plate and the second plate, the annular middle plate defining a cavity;
a rotor plate of the second valve positioned in the cavity having a first surface and a second surface, a plurality of through holes, a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3;
a chamber defined by the annular middle plate, the rotor plate, and the first plate of the second valve;
the through hole of the first plate of the second valve being in selective communication with the through hole of the rotor plate of the second valve, and the two or more additional through holes in the rotor plate of the second valve being in selective fluid communication with the two or more through holes in the second plate of the second valve; and
a shaft extending from the shaft cavity in the second plate of the second valve through the rotor plate and first plate of the second valve and the second plate and the rotor valve of the first valve to the shaft cavity of the first plate of the first valve, the shaft connected to the rotor plate of the first valve and the rotor plate of the second valve for rotating the rotor plate of the first valve and the rotor plate of the second valve.

12. The rotary valve assembly of claim 11 further comprising a second seal sheet having two or more openings corresponding to the two or more through holes in the second plate of the second valve, the second seal sheet positioned between a first side of the second plate of the second valve and a second side of the rotor plate of the second valve and wherein the second seal sheet is not attached to the second bottom plate or the second rotor plate.

13. The rotary valve assembly of claim 12 wherein a coefficient of friction of a bottom surface of the second seal sheet is greater than a coefficient of friction of a top surface of the second seal sheet.

14. The rotary valve assembly of claim 12 wherein the rotor plate of the second valve further comprises a counterbore in the second side of the rotor plate of the second valve in selective fluid communication with a low pressure cavity of the seal sheet of the second valve and a tail gas outlet in the second plate of the second valve.

15. A rotary valve assembly comprising:
a first valve comprising a first plate having a through hole and a shaft cavity; a second plate having two or more through holes and a shafthole; and an annular middle plate between the first plate and the second plate, the annular middle plate defining a cavity;
a rotor plate positioned in the cavity having a first surface and a second surface; a shaft hole; a through hole comprising an opening having an inner distance D1 from a center of the rotor plate, a center distance D2, and an outer distance D3; two or more additional through holes, each of the additional through holes being smaller than the first through hole in the rotor plate, and the two or more additional through holes being positioned on the rotor plate at a distance greater than or equal to D1 and less than or equal to D3; and a first covered channel extending from a first additional through hole to a second additional through hole at distance greater than or equal to D1 and less than or equal to D3;
a chamber defined by the annular middle plate, the rotor plate, and the first plate;
the through hole of the first plate being in selective communication with the through hole of the rotor plate, and the two or more additional through holes in the rotor plate being in selective fluid communication with the two or more through holes in the second plate;
a second valve comprising a first plate having a through hole and a shaft hole, a second plate having two or more through holes and a shaft cavity, and an annular middle plate between the first plate and the second plate, the annular middle plate defining a cavity;
a rotor plate of the second positioned in the cavity of the second valve having a first surface and a second surface, a plurality of through holes, a shaft hole; a through hole comprising an opening having an inner distance D1 from a center of the rotor plate, a center distance D2, and an outer distance D3; and two or more additional through holes, each of the additional through holes being smaller than the first through hole in the rotor plate, and the two or more additional through holes being positioned on the rotor plate at a distance greater than or equal to D1 and less than or equal to D3;
a chamber defined by the annular middle plate, the rotor plate, and the first plate of the second valve;
the through hole of the first plate of the second valve being in selective communication with the through hole of the rotor plate of the second valve, and the two or more additional through holes in the rotor plate of the second valve being in selective fluid communication with the two or more through holes in the second plate of the second valve; and
a shaft extending from the shaft cavity in the second plate of the second valve through the rotor plate and first plate of the second valve and the second plate and the rotor valve of the first valve to the shaft cavity of the first plate of the first valve, the shaft connected to the rotor plate of the first valve and the rotor plate of the second valve for rotating the rotor plate of the first valve and the rotor plate of the second valve.

16. The rotary valve assembly of claim 15 wherein the rotor plate of the second valve further comprises a first covered channel extending from the first additional through hole to the second additional through hole at distance greater than or equal to D1 and less than or equal to D3.

17. The rotary valve assembly of claim 15 further comprising a second covered channel in the rotor plate of the first valve, the second covered channel extending from a third additional through hole to a fourth additional through hole, the third additional through hole positioned between one end of the through hole in the rotor plate and the first additional through hole and the fourth additional through hole being positioned between the third additional through hole and the other end of the through hole in the rotor plate, the second covered channel at a distance greater than or equal to D1 and less than or equal to D3.

18. The rotary valve assembly of claim 15 further comprising:
a seal sheet having two or more openings corresponding to the two or more additional through holes in the second plate, the seal sheet positioned between a first side of the second plate and a second side of the rotor plate of the first valve, and wherein the seal sheet is not attached to the second plate or the rotor plate of the first valve; or
a second seal sheet having two or more openings corresponding to the two or more additional through holes in the second plate, the seal sheet positioned between a first side of the second plate and a second side of the rotor plate of the second valve, and wherein the seal sheet is not attached to the second plate or the rotor plate of the second valve;
or both.

19. The rotary valve assembly of claim 18 wherein a coefficient of friction of a bottom surface of the seal sheet of the first valve is greater than a coefficient of friction of a top surface of the seal sheet of the first valve; or
wherein a coefficient of friction of a bottom surface of the seal sheet of the second valve is greater than a coefficient of friction of a top surface of the seal sheet of the second valve;
or both.

20. The rotary valve assembly of claim 18 wherein the top surface of the seal sheet of the first valve further comprises a low pressure cavity in fluid communication with one of the two or more additional through holes in the second plate of the first valve; or
wherein the top surface of the seal sheet of the second valve further comprises a low pressure cavity in fluid communication with one of the two or more additional through holes in the second plate of the second valve;
or both.
